(19) United States
(12) Patent Application Publication
(10) Pub. No.: US 2020/0100476 A1
(43) Pub. Date: Apr. 2, 2020

(54) MAGNETICALLY SUSPENDED MOVABLE MAGNIFYING VIEWER

(71) Applicant: Duard Enoch, Santa Barbara, CA (US)

(72) Inventor: Duard Enoch, Santa Barbara, CA (US)

(21) Appl. No.: 16/586,056

(22) Filed: Sep. 27, 2019

Related U.S. Application Data
(60) Provisional application No. 62/737,632, filed on Sep. 27, 2018.

(51) Int. Cl. A01K 63/00; G02B 25/00; G02B 7/02

(52) U.S. Cl. CPC A01K 63/006; G02B 7/02; G02B 25/002

(57) ABSTRACT

A viewer for use with aquariums has a frame adapted to carry a magnifying lens. A magnetic element is operatively attached to the frame. A float bob has an internal magnetic element adapted to magnetically engage the magnetic element through an aquarium pane.

### REFERENCE TO RELATED APPLICATIONS

This application claims priority of US provisional application Ser. No. 62/737,632 filed on Sep. 27, 2019 entitled MAGNETICALLY SUSPENDED MOVABLE MAGNIFYING VIEWER, the disclosure of which is incorporated herein by reference.

### BACKGROUND INFORMATION

### Field

Implementations of the disclosure relate generally viewing devices for aquariums and, more particularly, magnetically suspended support frame for a magnifying lens.

Background

Aquarium owners often wish to view fish in their aquariums more clearly than just viewing through the glass or plastic walls typically allow. Magnifying devices which are attached to the exterior of the aquarium with suction cups or similar devices are available but are often difficult to attach and to move.

### SUMMARY

Implementations disclosed herein provide a viewer for use with aquariums has a frame adapted to carry a magnifying lens. A magnetic element is operatively attached to the frame. A float bob has an internal magnetic element adapted to magnetically engage the magnetic element through an aquarium pane.

### BRIEF DESCRIPTION OF THE DRAWINGS

The features, functions, and advantages of the anti-personnel autonomous vehicle can be achieved independently in various implementations of the present disclosure or may be combined in yet other implementations further details of which can be seen with reference to the following description and drawings.

FIG. 1 is a pictorial representation of an implementation of the present disclosure on an aquarium glass pane;

FIG. 2A is a front view of the magnifier support;

FIG. 2B is a side view of the magnifier support;

FIG. 2C is a detail partial perspective view of the magnifier support showing the magnet boss;

FIG. 2D is a side section view of the magnifier support;

FIG. 2E is a detail sectioned partial perspective view of the magnifier support showing the magnet boss, magnet and anti-abrasion pad;

FIG. 3 is a pictorial representation of the internal magnetic element and float bob; and,

FIG. 4 is a pictorial representation of an additional accessory attached to the float bob.

### DETAILED DESCRIPTION

Implementations disclosed herein provide a viewer for use with aquariums or other glass enclosures. The viewer incorporates an external frame configured to allow interchange of various magnifying lenses and supported from a boss containing an magnetic element. An internal magnetic element is supported by a buoyant float and, when in proximity of the magnetic element of the external frame, mutually retains the frame in a position on the glass wall.

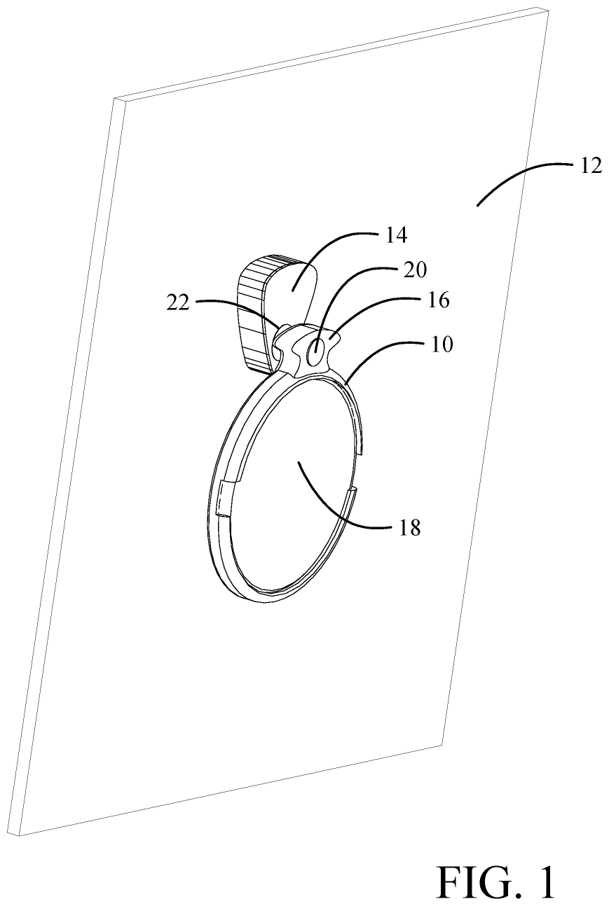

Referring to the drawings, FIG. 1 shows the external frame 10 supported on an aquarium pane 12 by a float bob 14 on the interior of the pane. The frame 10 depends from a boss 16 and engages a magnifying lens 18. The boss 16 houses a magnetic element 20. The float bob 14 carries an internal magnetic element 22 which engages the magnetic element 20 through the glass pane 12. Disconnection of the magnetic elements allows the frame to be removed from the glass and the float bob 14 has an internal buoyant volume 24 which causes the float bob to rise to the surface of the aquarium. The magnetic attraction between magnetic element 20 and internal magnetic element 22 frictionally engages the bloat bob 14 and boss 16 to the glass pane 12. As will be shown and describe subsequently, use of felt pads on the surfaces of the float bob and boss engaging the glass may be employed to avoid abrasion of the glass (or plastic) surfaces of the aquarium pane. The magnifier may be moved on the aquarium pane by grasping the boss and/or frame and sliding the boss and float bob along the pane to a desired position.

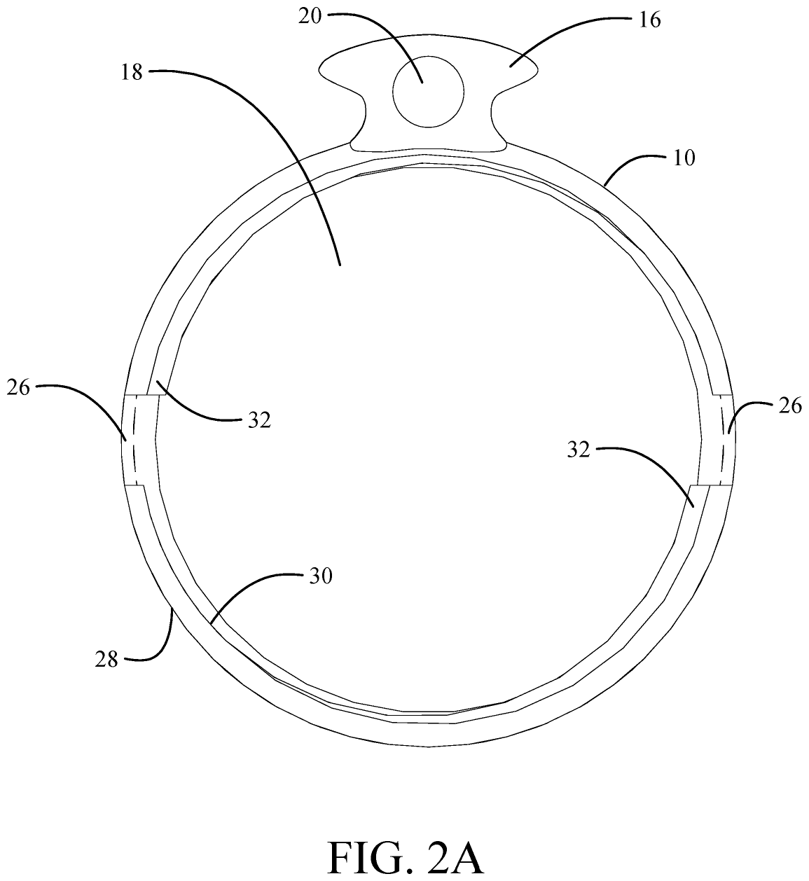

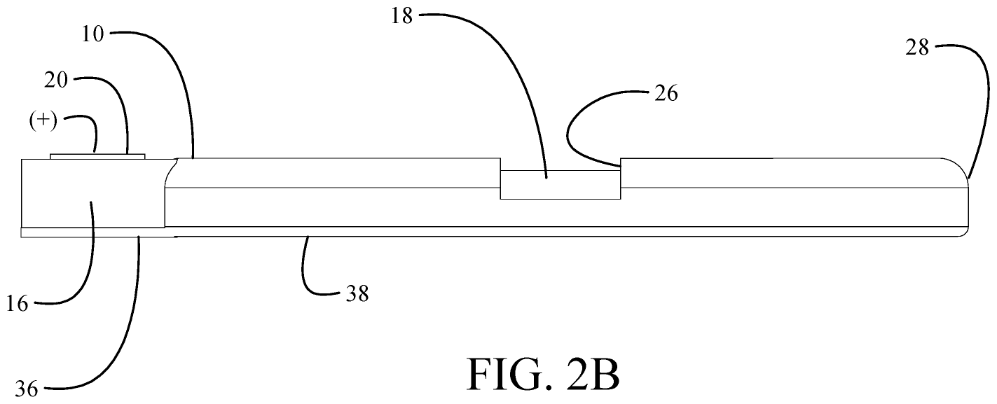

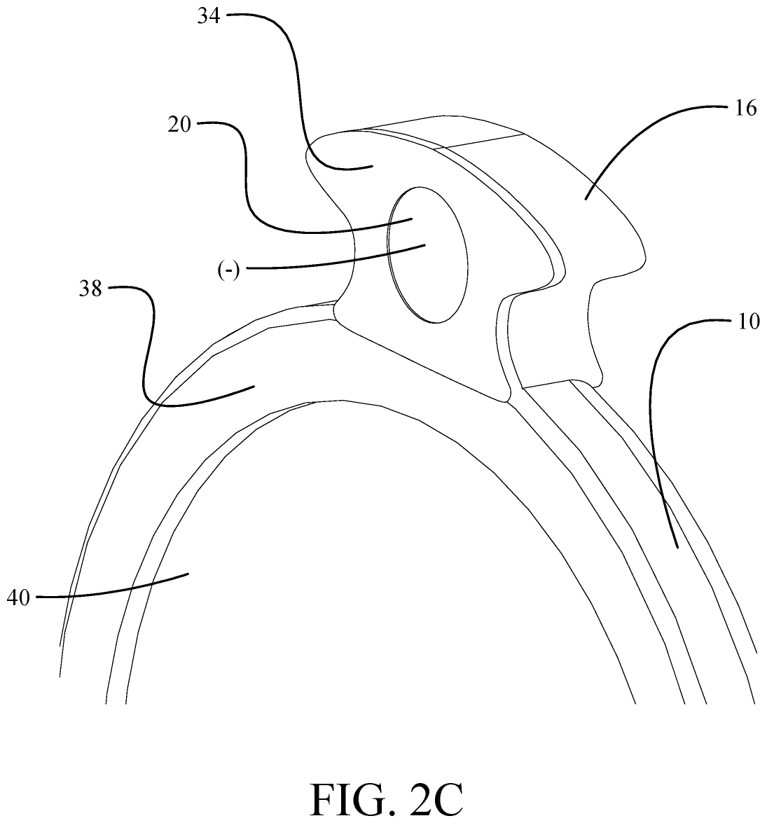

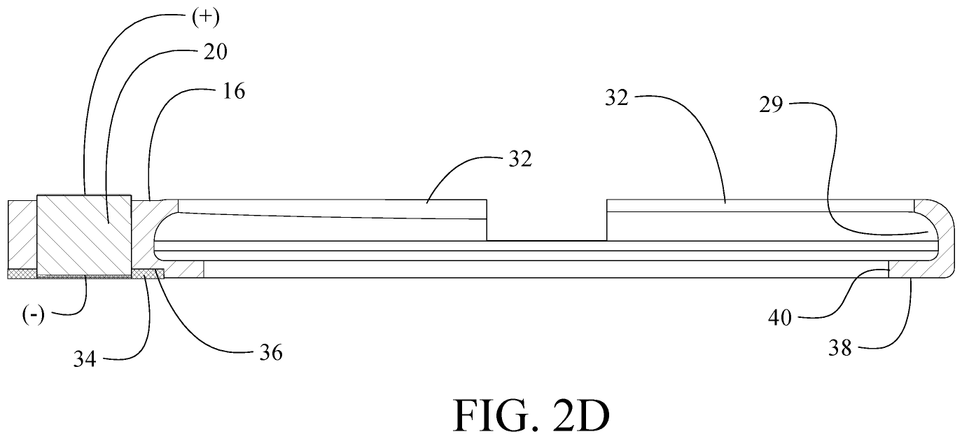

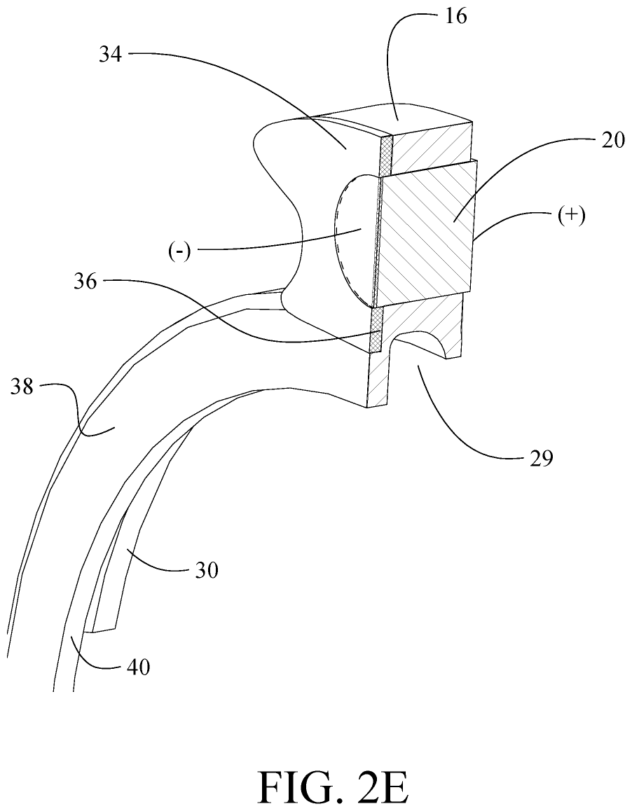

As seen in FIG. 2A and 2 B, the frame 10 depends from the boss 16 is contoured to allow easy grasping of the boss to position the frame. The frame 10 has a cross section as seen in FIGS. 2D and 2E (shown with the lens removed for clarity) which has substantially a channel shape 29 to allow insertion and retention of the magnifying lens 18. One or more slots 26 in the outer rim 28 of the frame accommodate insertion of the lens and at least the outer rim 28 is flexible to receive the lens. The entire frame may be maliable/flexible to ease in insertion and removal of lenses. For the embodiment shown, the outer rim 28 incorporates a central aperture 30 which is formed with offset cylindrical edges 32 allowing rotational insertion of the lens, deforming the edges 32. Slots 26 enhance the ease of insertion of the lens.

For the implementation shown, a felt pad 34 is positioned on (or in a relief in) the contacting surface 36 of the boss 16. While shown for the exemplary implementation as merely covering the contact surface of the boss, the felt pad may be applied to the interior surface 38 of the frame 10 as well. As seen FIGS. 2C, 2D and 2E the frame has an interior aperture 40 to allow viewing through the magnifying lens 28.

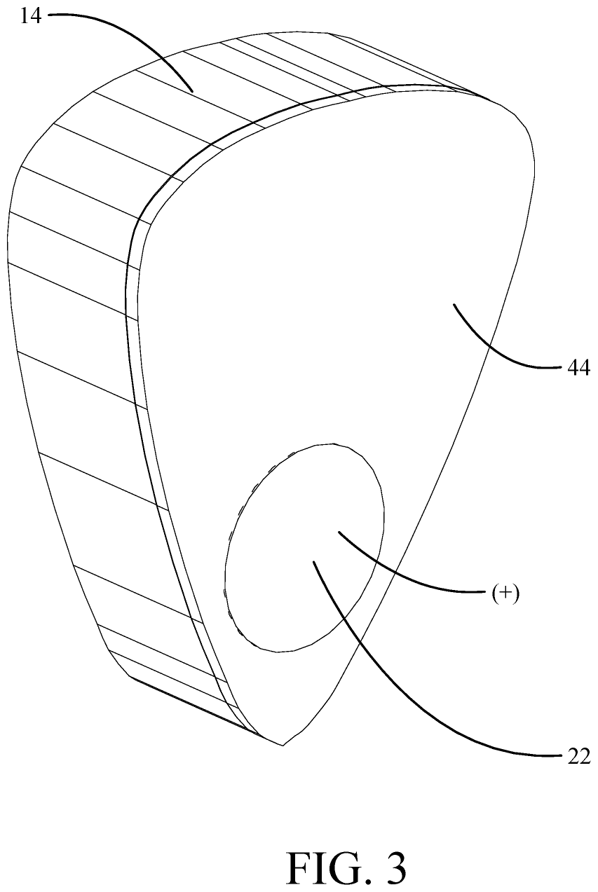

The float bob 14, as seen in FIG. 3, has a buoyant chamber or portion 42 configured to provide a buoyant volume to allow the float bob 14 and contained internal magnetic element 22 to float to the surface of the aquarium if magnetically disconnected from the boss 16. The float bob also incorporates a felt pad 44 adapted to contact the interior surface of the aquarium pane 12. In alternative embodiments, the buoyant chamber of the float bob may be separated from the internal magnetic element 22 and attached thereto by a lanyard or similar arrangement.

For the exemplary implementation, the magnetic element 20 and internal magnetic element 22 are both magnets with aligned polarities for mutual attraction as indicated in the drawings. In alternative implementations, one of the magnetic elements may be a magnet while the other element is a magnetically attractive metal coupon or plug.

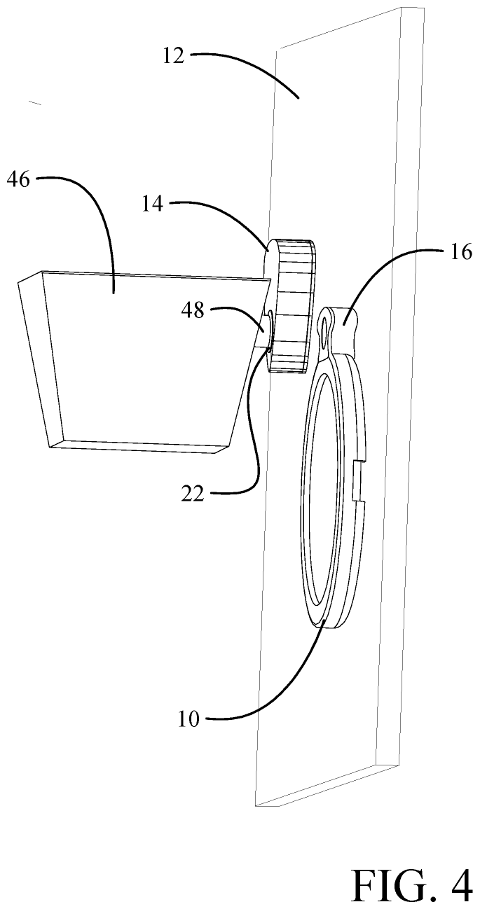

As seen in FIG. 4, the internal magnetic element 22 in the float bob 14 may be a magnet and an internal attachment such as a feeding tray 46 may incorporate a third magnetic element 48 magnetically attachable to the float bob whereby the float bob may act as an attracting element for fish to be viewed through the magnifying lens. Other tools such as cleaning devices or other accessories may be attached to the float bob.

Having now described various implementations of the disclosure in detail as required by the patent statutes, those skilled in the art will recognize modifications and substitutions to the specific implementations disclosed herein. Such modifications are within the scope and intent of the present disclosure as defined in the following claims.

What is claimed is:

1. A viewer for use with aquariums, said viewer comprising:
a frame adapted to carry a magnifying lens;
a magnetic element operatively attached to the frame;
a float bob having an internal magnetic element adapted to magnetically engage the magnetic element through an aquarium pane.

2. The viewer as defined in claim 1 wherein the frame has substantially a channel shape to allow insertion and retention of the magnifying lens.

3. The viewer as defined in claim 2 further comprising one or more slots in an outer rim of the frame accommodate insertion of the lens and at least the outer rim is flexible to receive the lens.

4. The viewer as defined in claim 1 wherein the frame has an outer rim incorporating a central aperture which is formed with offset cylindrical edges allowing rotational insertion of the lens, deforming the edges.

5. The viewer as defined in claim 1 wherein the frame depends from a boss and further comprising a felt pad positioned on or in a relief in a contacting surface of the boss to contact the exterior surface of the aquarium pane.

6. The viewer as defined in claim 5 wherein the float bob has a buoyant chamber with configured to provide a buoyant volume to allow the float bob and contained internal magnetic element to float to the surface of the aquarium if magnetically disconnected from the boss.

7. The view as defined in claim 6 wherein the float bob incorporates a second felt pad adapted to contact the interior surface of the aquarium pane.
